(19) United States
(12) Patent Application Publication
(10) Pub. No.: US 2024/0319998 A1
(43) Pub. Date: Sep. 26, 2024

(54) ON-CHIP AI COMPUTE HARDWARE ACCELERATION

(71) Applicant: International Business Machines Corporation, Armonk, NY (US)

(72) Inventors: Satish Kumar SADASIVAM, Erode (IN); Biplob MISHRA, Bangalore (IN); Puneeth A.H. BHAT, Bangalore (IN)

(21) Appl. No.: 18/187,465

(22) Filed: Mar. 21, 2023

(51) Int. Cl. G06F 9/50; G06F 7/50; G06F 7/523; G06F 7/544

(52) U.S. Cl. CPC G06F 9/5027; G06F 7/50; G06F 7/523; G06F 7/5443

(57) ABSTRACT

Systems and methods are disclosed for implementing an enhanced Matrix Math Assist (MMA) accelerator that accelerates additional Matrix Math operations of Matrix-Vector multiply and other Multiply-Add Compute operations. The Matrix Math Assist (MMA) accelerator can accelerate operations for mixed Matrix-Matrix, Matrix-Matrix and Matrix-Vector compute patterns. The MMA accelerator is an on-chip MMA accelerator built into a processor core with a set of defined registers and predefined instructions.

### BACKGROUND

The present invention relates to digital computing systems, and more specifically, to implementing an enhanced Matrix Math Assist (MMA) accelerator for accelerating Matrix-Matrix multiplication, Matrix Math operations of Matrix-Vector multiplication, other Multiply-Add compute and mixed Matrix-Matrix and Matrix-Vector compute patterns.

Single instruction, multiple data (SIMD) acceleration is a traditional architecture to accelerate the compute centric workloads. SIMD provides hardware support for performing an operation on multiple pieces of data, in parallel, using a single instruction. A Matrix Math Assist (MMA) unit or accelerator supports SIMD acceleration and can be used to accelerate Matrix-Matrix multiplication and can help boost the performance of General Matrix Multiply (GEMM) compute, which is a common algorithm in linear algebra, machine learning, statistics, and many other domains. Basic Linear Algebra Subprograms (BLAS) are a set of low-level subroutines that provide standard building blocks for performing common linear algebra operations, such as basic vector and matrix operations, regular multiply add and matrix-vector multiplication. Generally, the traditional on-chip MMA effectively implements matrix-matrix multiply operations or BLAS-3 routines using SIMD acceleration. Matrix Multiplication is one of the key primitives heavily used in AI workload. However, there is a huge dependency on regular multiply add type of operations (e.g., BLAS-1 and BLAS-2) other than matrix-matrix multiply operations. Traditional MMA units only weakly support SIMD acceleration to perform regular multiply add or matrix-vector multiplication.

### SUMMARY

Embodiments of the present disclosure provide a system and methods for implementing an enhanced Matrix Math Assist (MMA) accelerator for accelerating Matrix Math operations of Matrix-Vector multiply, Multiply-Add compute and mixed Matrix-Matrix multiply and Matrix-Vector multiply compute patterns.

A disclosed non-limiting computer-implemented method accelerates Matrix-Vector multiply and Multiply-Add compute operations with a Matrix Math Assist (MMA) accelerator. Predefined instructions are provided to support specific operations of the MMA accelerator for implementing for Matrix-Vector multiply operations and Multiply-Add compute operations. An accumulator of a compute engine (of the MMA accelerator) mapped to multiple defined input registers helps accelerate compute operations with the compute engine. A respective matrix input from one of the multiple Vector Scalar Registers (VSRs) is input to a respective row of a compute engine array based on one predefined instruction. A respective vector element from one VSR is input to the respective rows and multiplied with the respective matrix input based on the predefined instruction. The compute engine generates compute results, which are summed to the accumulator of the compute engine. In each next compute iteration, the summed multiply compute results are accumulated to the contents of the accumulator and the compute iterations are repeated to complete the Matrix-Vector multiply operations.

### BRIEF DESCRIPTION OF THE DRAWINGS

FIG. 1 is a block diagram of an example computer environment for use in conjunction with one or more disclosed embodiments for implementing an enhanced Matrix Math Assist (MMA) accelerator for accelerating of Matrix Math operations of Matrix-Vector multiply, Multiply-Add compute and mixed Matrix-Matrix multiply and Matrix-Vector multiply compute patterns;

FIG. 2 is a block diagram of an example system for implementing enhanced acceleration of Matrix Math operations of Matrix-Vector multiplication, other Multiply-Add compute and mixed Matrix-Matrix and Matrix-Vector compute patterns of one or more disclosed embodiments;

FIG. 3 is a block diagram of an example enhanced Matrix Math Assist (MMA) accelerator of the system of FIG. 2 of one or more disclosed embodiments;

FIG. 4 is a flow chart of example program library operations of an example method for implementing acceleration of Matrix Math operations of Matrix-Vector multiplication, other Multiply-Add compute and mixed Matrix-Matrix multiply and Matrix-Vector multiply compute patterns with the MMA accelerator of FIG. 3 of one or more disclosed embodiments;

FIG. 5 is a flow chart of an example method for implementing the enhanced Matrix Math Assist (MMA) accelerator of the system of FIG. 2 of one or more disclosed embodiments;

FIG. 6 illustrates an example pseudo code of an example novel instruction for Matrix-Vector multiply acceleration of one or more disclosed embodiments;

FIG. 7 illustrates an example for acceleration of an Matrix-Vector multiply operation of one or more disclosed embodiments;

FIG. 8 illustrates an example Matrix-Vector multiply operation implemented by the MMA accelerator of one or more disclosed embodiments;

FIG. 9 illustrates an example for acceleration of Matrix-Vector multiply operation of one or more disclosed embodiments; and

FIG. 10 illustrates an example for acceleration of AXPY (aX plus Y) or Vector Multiply-Add compute operation of one or more disclosed embodiments.

### DETAILED DESCRIPTION

Disclosed embodiments provide systems and methods for implementing an on-chip Matrix Math Assist (MMA) accelerator that accelerates additional Matrix Math operations of Matrix-Vector multiply and other Multiply-Add Compute operations. The MMA accelerator enables Matrix Math operations for mixed Matrix-Matrix and Matrix-Vector compute patterns. The MMA accelerator can be implemented with an on-chip MMA accelerator built into a processor core with a set of defined registers and predefined instructions added to an instruction set architecture (ISA) for Matrix Math operations of a MMA compute engine, Matrix-Vector multiply and other Multiply-Add Compute operations.

In accordance with disclosed embodiments, the enhanced MMA accelerator enables accelerating computes efficiently without wasting or discarding the partial products, thereby saving thermal power. The enhanced MMA accelerator can eliminate the need for data movement of the results of Matrix-Matrix compute to other types of computes like Matrix-Vector or Vector-Vector computes in certain applications. The enhanced MMA accelerator supports accelerating non Matrix-Matrix integer and lower precision computes within MMA without any additional simple Vector Scalar (VS)-Units. The enhanced MMA extends the support for lower precisions, integer precisions and mixed precisions operations for all compute patterns.

In accordance with disclosed embodiments, a method and system for implementing on-chip Artificial Intelligence (AI) hardware compute acceleration provides an enhanced MMA (Matrix Math Assist) accelerator. In one disclosed embodiment, the enhanced MMA accelerator enables Matrix Math operations for acceleration of Matrix-Vector multiply operations and acceleration of AXPY (aX plus Y) operations. The AXPY operation computes a vector-scalar product and adds the result to a vector. The enhanced MatrixMatrix Math Assist (MMA) accelerator effectively and efficiently enables previously not possible acceleration operations for Matrix-Vector multiply and AXPY Multiply-Add Compute operations. In a disclosed embodiment, the enhanced MMA includes an input configuration of a set of defined Vector Scalar Registers (VSRs) for matrix data inputs and for a vector data input. In a disclosed embodiment, the enhanced MMA includes a controlled data feed enabled by predefined Vector Scalar Extension (VSX) instructions for implementing dense numerical linear algebra computations for Matrix-Vector multiply operations and other Multiply-Add Compute. In a disclosed embodiment, a minimal number of additional VSX instructions over currently available VSX instructions supports and accelerates the Matrix-Vector multiple and other Multiply-Add Compute operations, without modifying the capability of a traditional on-chip MMA compute engine. The MMA accelerator supports operations for all data precision levels of Floating Point and Integer operations.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

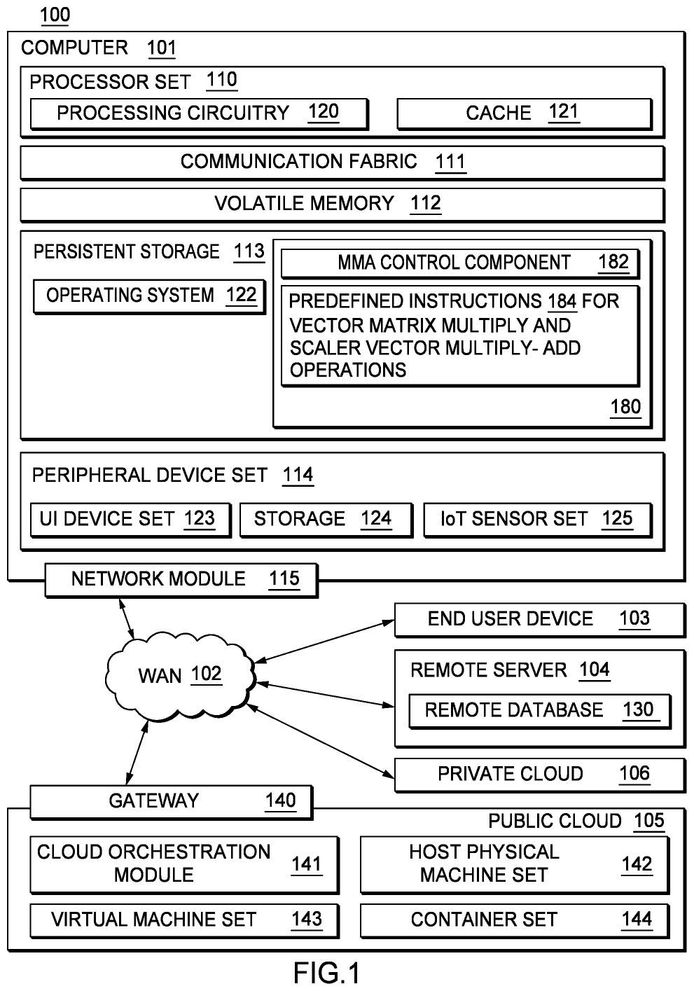

Referring to FIG. 1, a computing environment 100 contains an example of an environment for the execution of at least some of the computer code involved in performing the inventive methods, such as a MMA control component 182 and predefined additional VSX instructions 184 at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Embodiments of the present disclosure provide a system and methods implement an enhanced on chip Matrix Math Assist (MMA) accelerator that functions to perform Matrix-Vector multiplication and Multiply Add operations. Current on-chip MMA accelerators use Matrix-Multiply Assist instructions that lead to very efficient implementations for high performance computing with an integral compute engine, implementing dense numerical linear algebra computations of Matrix-Matrix multiply operation. In one disclosed embodiment, the enhanced MMA accelerator is not limited to the Matrix-Matrix multiply operations. The enhanced MMA accelerator can implement for example, a method to perform 512 bit multiply add operation, in order to support Matrix-Vector multiplication and Multiply Add operations (e.g., BLAS-1 and BLAS-2 routines) without increasing the native vector length (currently 128 bit for VSX), native register file size and without adding any new compute capability. In one disclosed embodiment, the enhanced MMA accelerator can leverage an existing register file architecture and leverage the currently available compute engine capability of existing on-chip MMA technology to support the new Matrix Math operations.

In one disclosed embodiment, a system and method can implement the enhanced MMA accelerator and acceleration operations by adding a selected number of register-files for matrix and vector data input to a compute engine with data flow redefined to achieve the Matrix-Vector and other Multiply-Add functionalities. The disclosed system and method can extend traditional MMA accelerator capabilities by defining an extension of Vector Scalar Extension (VSX) instructions to an instruction set architecture (ISA) for the MMA accelerator with a small number of supporting VSX instructions for Matrix-Vector multiplication and Multiply-Add functionalities added to the existing MMA ISA. The disclosed MMA accelerator enables enhanced operations for Matrix-Vector multiply and other Multiply-Add operations, and supports both floating-point and integer data types with lower/integer precision data for matrix-vector multiply and multiply add operations. The disclosed system and method advantageously can reuse a full compute capability of an existing on-chip MMA compute engine for matrix-vector computation without any waste of compute results or processing power.

In a disclosed embodiment, a system and method utilize the enhanced Matrix Math Assist (MMA) accelerator that significantly extend the capabilities of an existing MMA accelerator. The enhanced MMA accelerator provides a Matrix-Vector multiply operation using a redefined data flow and a plurality of Vector Scalar Register (VSR) inputs from the matrix and a VSR input from the vector coupled to a MMA compute engine.

In a disclosed embodiment, enhanced system performance and value are provided by the MMA accelerator with defined instructions added to the MMA ISA for the Matrix-Vector multiply operation and other multiply-add functionalities. The enhanced MMA accelerator accelerates Matrix Math operations for Matrix-Vector product and other multiply-add operations supporting floating point and integer operations with defined precision levels. The enhanced MMA accelerator can use the full compute capability of an available on-chip MMA compute engine for accelerating matrix-vector and other multiply-add compute operations without waste of compute engine computation, and that can minimize power consumption.

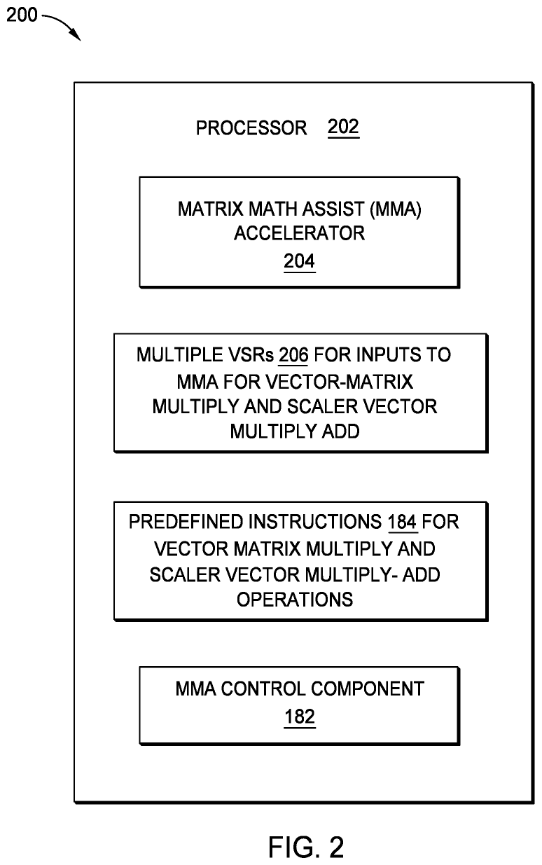

FIG. 2 illustrates an example system 200 for implementing enhanced acceleration of Matrix Math operations of Matrix-Vector multiply, Multiply-Add compute and mixed Matrix-Matrix and Matrix-Vector compute patterns of one or more disclosed embodiments. System 200 includes a processor 202 and an enhanced MMA 204 implementing enhanced Matrix Math operations of the disclosed embodiments. MMA accelerator 204 is an on-core accelerator built into processor 202 with registers and ISA for operations. System 200 includes a plurality of defined Vector Scalar Registers (VSRs) 206 for inputs to the enhanced MMA accelerator 204 to implement the enhanced Math Assist operations including Matrix-Vector and other Multiply-Add functionalities.

For example, processor 202 can be implemented with at least one integrated on-chip MMA accelerator 204 with a MMA ISA updated with additional predefined instructions and additional VSRs 206 of disclosed embodiments. Processor 202 can include one or more MMA accelerators 204, for example integrated into one or more multiple processor cores.

For example, processor 202 can include a processor-core micro-architecture enabling flexibility, large caches, and reduced latencies. System 200 can leverage an existing register file architecture with added VSRs 206 and on-chip compute engine capability for example to implement the enhanced MMA accelerator 204 with enhanced performance and reduced power consumption.

System 200 includes a MMA control component 182 used with predefined additional VSX instructions 184 and the defined VSRs 206 for MMA inputs, to accelerate Matrix-Vector multiply, Multiply-Add compute and mixed Matrix-Matrix multiply and Matrix-Vector multiply compute operations over the traditional VSX instructions of processor 202. The enhanced MMA accelerator 204 enables acceleration of the Matrix-Vector Multiply and AXPY implementations with the defined VSRs 206 for MMA inputs and the predefined VSX instructions 184 of disclosed embodiments.

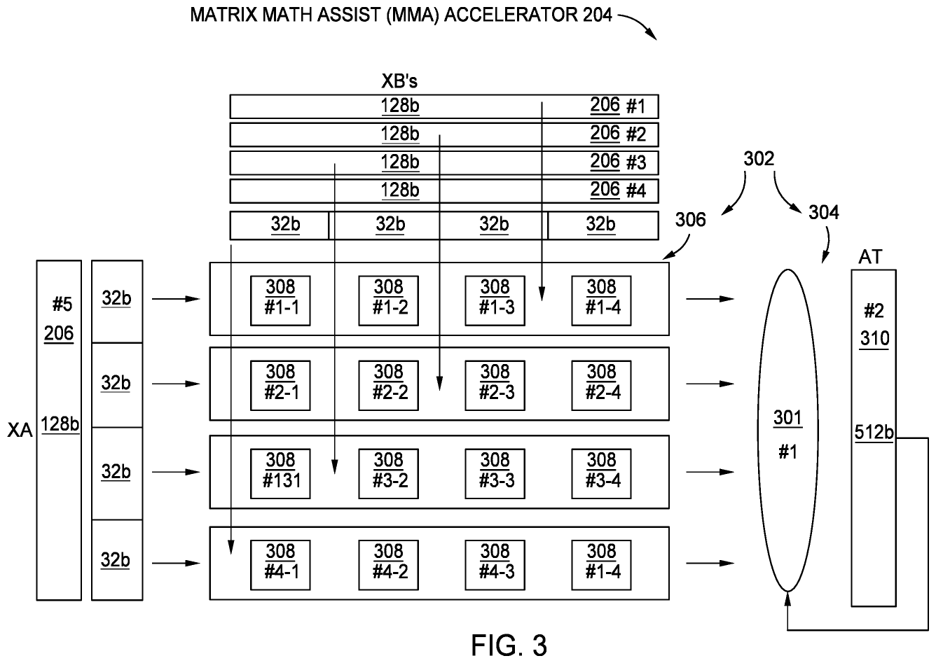

FIG. 3 illustrates an example enhanced MMA accelerator 204 of system 200 in accordance with disclosed embodiments. The MMA accelerator 204 is described with an example illustrative embodiment for a 32-bit float implementation, and a length of the VSR registers 206 of 128-bits, which can store four (4) 32-bit floating point elements. Features of the disclosed MMA accelerator 204 can be used with various different implementations, and is not limited to the illustrative embodiments.

The disclosed enhanced MMA accelerator 204 for example, can use the added VSX instructions 184 and the multiple additional VSR registers 206 configured to feed matrix and vector data way to a MMA compute engine 302 based on one VSX instruction 184. MMA compute engine 302 implements numerical linear algebra operations to generate, for example a 512 bit arithmetic compute, which is summed to an accumulator 304.

In a disclosed embodiment, system 200 includes five (5) VSRs 206 #1-#5 (each 128-bits storing four 32-bit elements) for inputs to the compute engine 302 of the enhanced MMA accelerator 204. For example, compute engine 302 includes a configuration and arrangement of an available on-chip MMA compute engine implemented with a Power10 processor core. MMA accelerator 204 for example, receives four matrix inputs pertaining to VSRs 206 #1-#4 (16 matrix elements in total) and one vector input pertaining to one (1) VSR 206 #5 (4 elements) to implement the enhanced Matrix Math Assist operations including Matrix-Vector multiply and other Multiply-Add compute operations. For example, compute engine 302 receives data inputs from the VSRs 206 #1-#5 and predefined related VSX instructions 184 to implement numerical linear algebra operations on small Matrixes of the compute engine to accelerate computation-intensive kernels, for Matrix-Vector multiply and other Multiply-Add operations.

The MMA accelerator 204 includes the compute engine 302 comprising an accumulator 304 mapped to a compute array matrix 306. For example, the accumulator 304 is a 512 bit accumulator utilizing a native vector length of 128 bit. For example, the compute array 306 comprises a 4×4 array of 16 compute elements 308 #1-#16, including four rows of four elements 308, #1-4, #2-4, #3-4, #4-4. Each array row provides a sum of the compute element values to provide 32-bit results (a total of 512 bits of output). The 32-bit results output is accumulated with the content of accumulator 304 comprising a pair of 512 bit accumulator registers 310 #1, #2. For a Matrix-Vector Multiply operation, matrix elements (from VSRs 206 #1-#4) are not reused, and the vector elements (from VSRs 206 #5) are reused in the compute engine 302, where multiple compute elements can operate in parallel depending on the matrix size and can improve reusability of the vector elements. Multiple VSR 206 #1-#4 are input for the matrix elements and one VSR 206 #5 input for the vector element. Each value of the VSR 206 #1-#4 matrix inputs, #1-4, #2-4, #3-4, #4-4 is multiplied by a respective corresponding elements from the vector input 206, #5 providing respective results in the respective rows #1-4 that are added to generate 1 output vector element. For example, element1 of VSR 206 #5 is multiplied to respective elements of a subset of inputs of the first VSR 206 #1 of matrix in a first result subset. Element2 of VSR 206 #5 is multiplied to respective elements of the second VSR 206 #2, and so on. The multiply results are zero/positive/negative accumulated to the 512-bit accumulator 304.

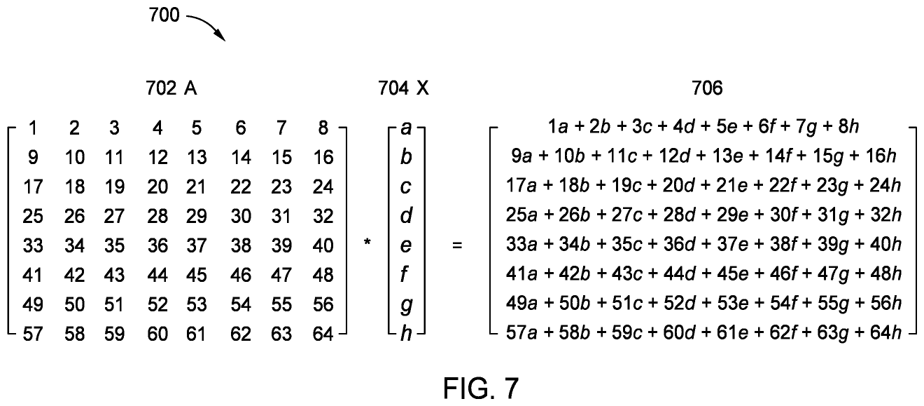

FIG. 7 illustrates an example Matrix-Vector multiply operation 700 of one or more disclosed embodiments. The illustrated multiply operation 700 includes a matrix 702 A that is multiplied with a vector 704 X producing respective multiply results 706. The illustrated matrix 702 is an 8×8 (M×N) matrix including in total 64 elements, eight respective consecutive elements included in each of eight rows, with matrix row 1 comprising 8 elements 1-8, matrix row 2 comprising 8 elements 9-16, and continuing with matrix row 8 comprising 8 elements 57-64. The illustrated vector 704 X includes eight vector elements a, b, c, d, e, f, g, and h. Each element of row1 of the matrix 702 is multiplied by the corresponding elements of the vector 704 and all multiplied results of row 1 are added to generate 1 output vector element. This multiply, add compute is repeated for all rows 2-8 in the matrix 702. The number of output elements generated is M. The multiply results 706 includes eight multiply results, with each row of the eight rows including eight multiplied results summed together providing a respective Matrix-Vector multiply result. A first multiply result 706 includes the sum of elements 1a+2b+3c+4d+5e+6f+7g+8h, and continuing through an eighth multiply result of the sum of elements 57a+58b+59c+60d+61e+62f+63g+64h. The multiply results can be zero/positive/negative accumulated to the 512-bit accumulator.

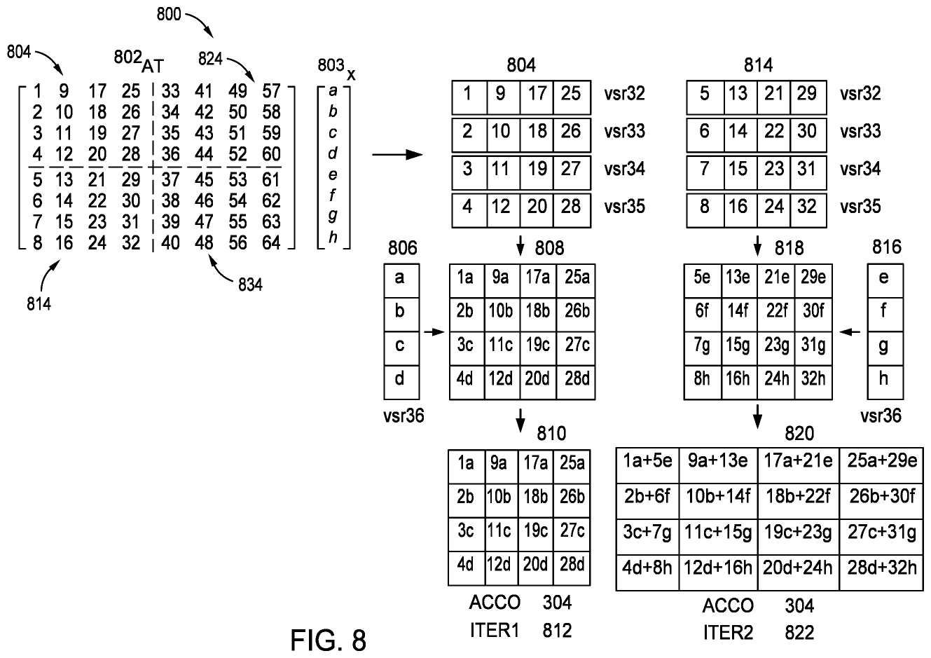

Referring again to FIG. 3, and referring to FIG. 8, the disclosed MMA accelerator 204 is used to perform a Matrix-Vector multiply operation using an 8×8 (M×N) matrix including in total 64 elements such as illustrated in FIG. 7. FIG. 8 illustrates an example Matrix-Vector multiply operation 800 implemented by the MMA accelerator 204 of one or more disclosed embodiments. MMA accelerator 204 uses the compute engine 302, which includes the compute engine 4×4 array 306 and performs multiple compute (e.g., 512-bit compute) iterations to complete the acceleration of the Matrix-Vector multiply operation 800.

As shown in FIG. 8, the matrix 702 A is transformed into a matrix 802 AT to be multiplied by the vector 803 x, for example including eight elements a, b, c, d, e, f, g, h. The transformed matrix 802 AT is an 8×8 (M×N) matrix including in total 64 elements, eight respective continuous elements included in each of eight columns, with matrix column 1 comprising 8 elements 1-8, matrix column 2 comprising 8 elements 9-16, and continuing to matrix column 8 comprising 8 elements 57-64. The matrix 802 AT is divided into four 4×4 subMatrixes 804, 814, 824, and 834 as illustrated by dashed lines. The illustrated 4×4 submatrix 804 is processed (matrix vector multiply) in a first iteration and the illustrated 4×4 submatrix 814 is processed in a second iteration of the Matrix-Vector multiply operation 800.

As illustrated the elements of first submatrix 804 of the matrix 802 AT are loaded with elements from the VSR 206 #1-#4 and respective 4 elements 806 a, b, c, d are input from the vector 803 of VSR 206, #5. The matrix and vector inputs are multiplied providing multiply results 808 as illustrated in respective rows 1-4 of row 1: 1a, 9a, 17a, 25a; row 1: 2b, 10b, 18b, 26b; row 3: 3c, 11c, 19c, 27c; and row 4: 4d, 12d, 20d, 28d. That is, the first element a 806 of vector VSR 206, #5 is multiplied with each element of the first row of submatrix 804 from VSR 206 #1. The second element b 806 of vector VSR 206, #5 is multiplied with each element of the second row of submatrix 804 from VSR 206 #2. The third element c 806 of vector 803 of VSR 206, #5 is multiplied with each element of the third row of submatrix 804 from VSR 206 #3. The fourth element d 806 of vector VSR 206, #5 is multiplied with each element of the fourth row of submatrix 804 from VSR 206 #4. These respective multiply results 810 are output to mapped accumulator registers ACC0 of the accumulator 304, completing the first iteration 812. For example, the 512-bit accumulator 304 is mapped to the 4 VSRs 206 for partial sum result from each of multiple iterations to provide the completed Matrix-Vector multiply operation 800 by the MMA 204.

Similarly, the second submatrix 814 of the matrix 802 AT are loaded with respective elements from the VSR 206 #1-#4 and respective next 4 elements 816 e, f, g, h are input from the vector VSR 206, #5. The matrix and vector inputs are multiplied providing multiply results 818 as illustrated in respective rows 1-4 of row 1: 5e, 13e, 21e, 29e; row 2: 6f, 14f, 22f, 30f; row 3: 7g, 15g, 23g, 31g; row 4: 8h, 16h, 24h, 32h. The multiply results 818 are output to mapped the accumulator registers ACC0 of the accumulator 304 and added to the first iteration accumulator partial sum results 810 to provide the second accumulator partial sum results 820, completing the second iteration 822. The second accumulator multiply results 820 of the accumulator registers ACC0 of the accumulator 304 include respective rows 1-4 of 1a+5e, 9a+13e, 17a+21e, 25a+29e; row 2: 2b+6f, 10b+14f, 18b+22f, 26b+30f; row 3: 3c+7g, 11c+15g, 19c+23g, 27c+31g; row 4: 4d+8h, 12d+16h, 20d+24h, 28d+32h, as shown. The operations of second iteration 822 are repeated in the same way, in a third iteration for submatrix 824 and again in a fourth iteration for submatrix 834. The partial sum results are accumulated for the third iterations and the fourth iteration partial sum results to ACC0 of the accumulator 304 to provide the complete results of the example Matrix-Vector multiply operation 800 by the MMA 204.

It should be understood that principles of the present disclosure are not restricted or limited to transformed way of multiplication, (this is an illustrative example to aid contiguous data loading). For example, principles of the present disclosure can be implemented with available matrix on processor providing strided data loading.

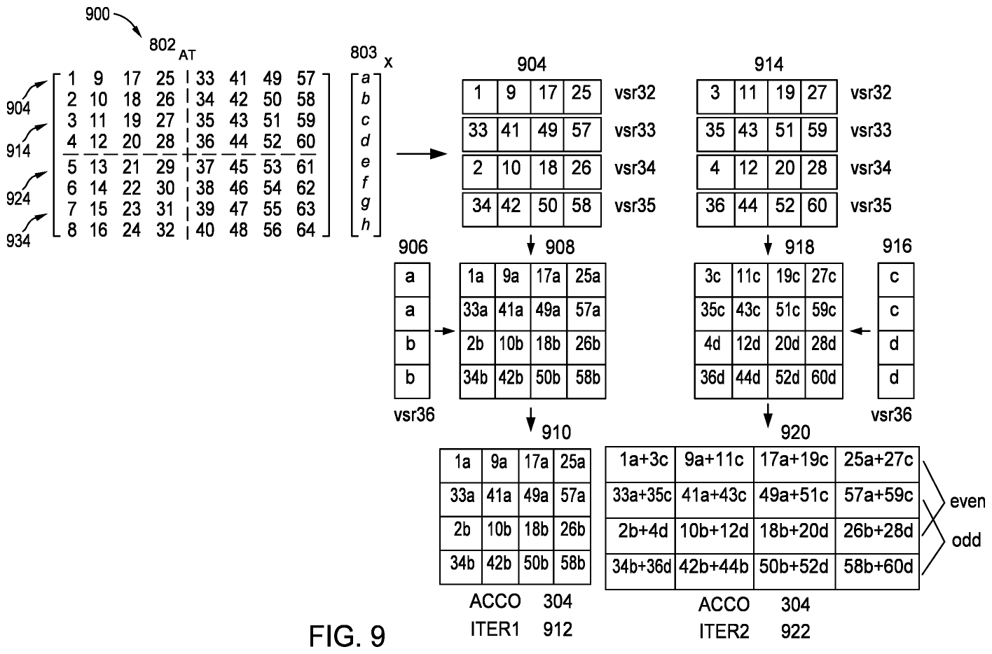

FIG. 9 illustrates another example Matrix-Vector multiply operation 900 by the MMA 204 of one or more disclosed embodiments. As shown in FIG. 9, the Matrix-Vector multiply operation 900 begins with the matrix 702 transformed into the matrix 802 AT to be multiplied by the vector 803 x, including the eight elements a, b, c, d, e, f, g, h, as shown in FIG. 8. The matrix 802 AT is divided into four 2×8 Sub-Matrices 904, 914, 924, and 934 as illustrated by dashed lines.

In a first iteration of the Matrix-Vector multiply operation 900 of compute engine 302, the elements of first submatrix 904 of the matrix 802 AT are loaded with elements from the VSR 206 #1-#4 and respective vector elements 916 a, a, b, b are input from the vector 803 of VSR 206, #5. The matrix and vector inputs are multiplied providing multiply results 908. In this example Matrix-Vector multiply operation 900, the first submatrix 904 includes 8 elements from row1, row2 of the matrix 802 AT. Only two elements from the vector 803 of VSR 206, #5 are used in each iteration, increasing the reusability of the vector elements.

As illustrated the multiply results 908 in respective rows 1-4 of row 1: 1a, 9a, 17a, 25a; row 2: 33a, 41a, 49a, 57a; row 3: 2b, 10b, 18b, and 26b; and row 4: 34b, 42b, 50b, 58b. These respective multiply results 908 provide outputs 910 mapped to accumulator registers ACC0 of the accumulator 304, completing the first iteration 912. For example, the 512-bit accumulator 304 is mapped to the 4 VSRs 206, #1-4 receiving a partial sum results 910 mapped from multiply results 908 for the first iteration, starting with initial zero values in accumulator registers ACC0. The 512-bit accumulator 304 sequentially receives and combines a partial sum result from each of multiple (e.g., four) iterations to provide the completed Matrix-Vector multiply operation 800 by the MMA 204.

In a second iteration of the Matrix-Vector multiply operation 900 of compute engine 302, the elements of second submatrix 914 of the matrix 802 AT are loaded with elements from the VSR 206 #1-#4 and respective vector elements 906 c, c, d, d are input from the vector 803 of VSR 206, #5. The matrix and vector inputs are multiplied providing multiply results 918 as illustrated in respective rows 1-4 of row 1: 3c, 11c, 19c, 27c; row 2: 35c, 43c, 51c, 59c; row 3: 4d, 12d, 20d, 28d; row 4: 35d, 44d, 52d, 60d. The second iteration multiply results 918 are added to the first iteration multiply results 908 to provide a next second partial sum result 920 to accumulator registers ACC0 of the accumulator 304, completing the second iteration 922, as shown. Results for output can be obtained by adding the even and odd column elements of the accumulator ACC0 as indicated with the next second partial sum result 920.

A third iteration of the Matrix-Vector multiply operation 900 of compute engine 302 can be performed the same way as the second iteration for the submatrix 924 with respective elements from the VSR 206 #1-#4 and respective vector elements 906 e, e, f, f are input from the vector 803 of VSR 206, #5. The third iteration multiply results are added to the second partial sum results 920 to provide the third accumulated partial sum results. A fourth iteration of the Matrix-Vector multiply operation 900 of compute engine 302 is performed the same way for the submatrix 934. The fourth iteration receives respective input elements from the VSR 206 #1-#4 for the submatrix 934 and respective vector elements 906 g, g, h, h from the vector 803 of VSR 206, #5. The fourth iteration is completed and the fourth multiply results are added to the third partial sum result to provide the completed result for the Matrix-Vector multiply operation 900.

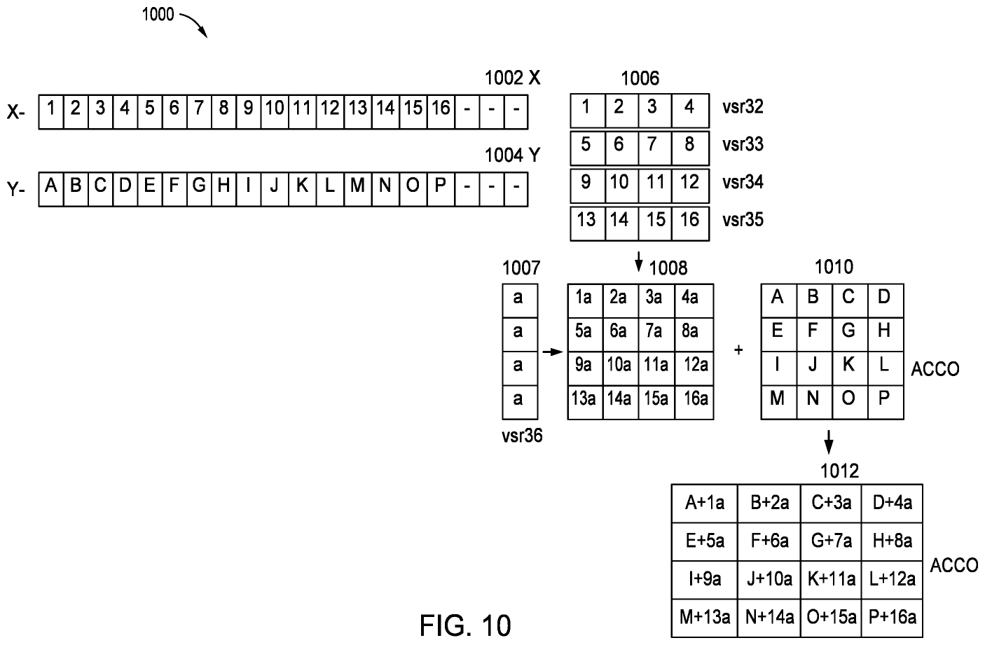

FIG. 10 illustrates an example compute operation 1000 of the MMA accelerator 204 for acceleration of AXPY (ax plus y) or Vector Multiply-Add compute of one or more disclosed embodiments. The Vector Multiply-Add compute operation 1000 provides an example for AXPY loops such as y=a*X+Y, where X and Y are vectors, and a is scalar. As shown, a vector 1002 X includes sixteen (16) elements 1-16 and a vector 1004 Y includes sixteen (16) elements A-P. As shown, compute engine 302 receives a 4×4 array 1006 of vector X elements 1-16 from the VSR 206 #1-#4, with row 1 containing elements 1-4 from VSR 206 #1, row 2 containing elements 5-8 from VSR 206 #2, row 3 containing elements 9-12 from VSR 206 #3, and row 4 containing elements 13-16 from VSR 206 #4. A scalar value a 1007 is loaded into each element a, a, a, a of the VSR 206 #5, and multiplied with the vector X elements 1-16 providing matrix multiply results 1008 as illustrated in respective rows 1-4 of row 1: 1a. 2a, 3a, 4a; row 2: 5a, 6a, 7a, 8ap row 3: 9a, 10a, 11a, 12a; and row 4: 13a, 14a, 15a, 16a. The accumulator ACC0 is loaded with the 16 consecutive elements A-P of vector 1006 Y. The matrix multiply results 1008 are added with the 16 consecutive elements A-P 1010 of accumulator ACC0 of the accumulator 304 to provide the accumulated results 1010, as shown. In a disclosed embodiment, a single MMA instruction can implement a 16 elements multiply accumulate compute to drive an AXPY loop.

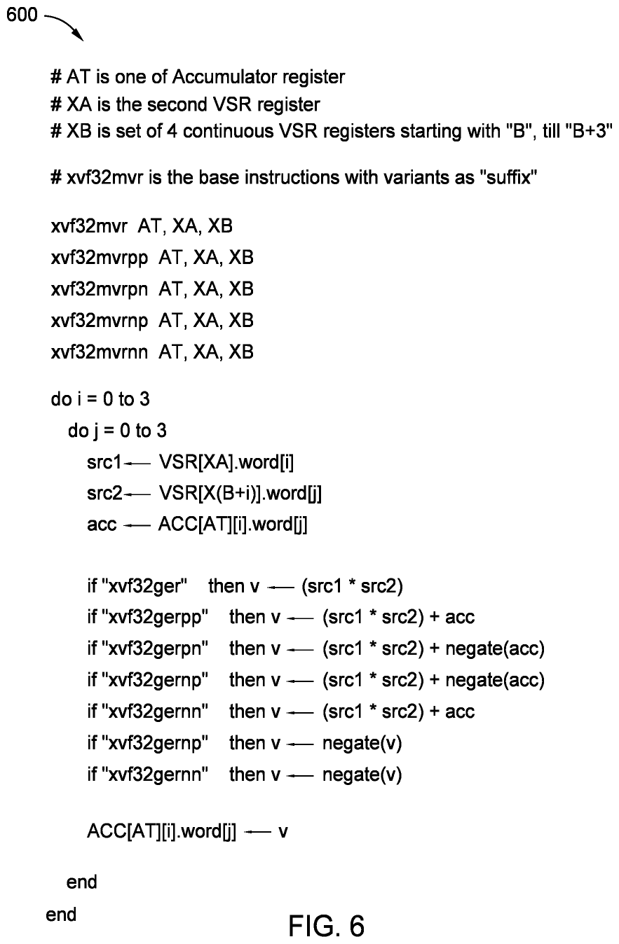

FIG. 6 illustrates an example pseudo code 600 of an example novel instruction for Matrix-Vector multiply acceleration of one or more disclosed embodiments. In the example pseudo code 600 of FIG. 6, #AT is one of Accumulator register, #AT is one of Accumulator register (e.g., accumulator 304), XA is second VSR register (e.g., VSR 206 #5), and XB is set of four (4) continuous VSR registers starting with “B”, till “B+3” (e.g., VSR 206 #1-#4). In the example pseudo code 600, #xvf32mvr represent base instructions with any of variants described as “suffix.” In the example pseudo code 600, the logic supports all type conversions and setting for all required floating-point precision and exception registers accordingly. The illustrated logic of pseudo code 600 may be extended for all data precision levels from Floating Point and Integer. The illustrated logic of pseudo code 600 may be used to implement additional variants such as using the example instructions 184 with masks to skip any of the multiply-adds accordingly.

Example instructions 184 are provided in the pseudo code 600 for acceleration of matrix-vector multiply and AXPY implementations that support 32-bit single precision implementations. The given example instructions 184 can be extended to handle lower precision (both integer and float), mixed precision and double-precision float implementations. The example instructions 184 in the pseudo code of FIG. 6 include the above described registers VSR 206 #1-#5, which are referred to as vs32, vs33, vs34, vs35, and vs36. The example arithmetic instructions 184 have an optional 2-letter suffix that indicates how the product of the input Matrixes should be added to the target accumulator: pp—positive product, positive accumulator, np—negative product, positive accumulator, pn—positive product, negative accumulator, nn—negative product, negative accumulator.

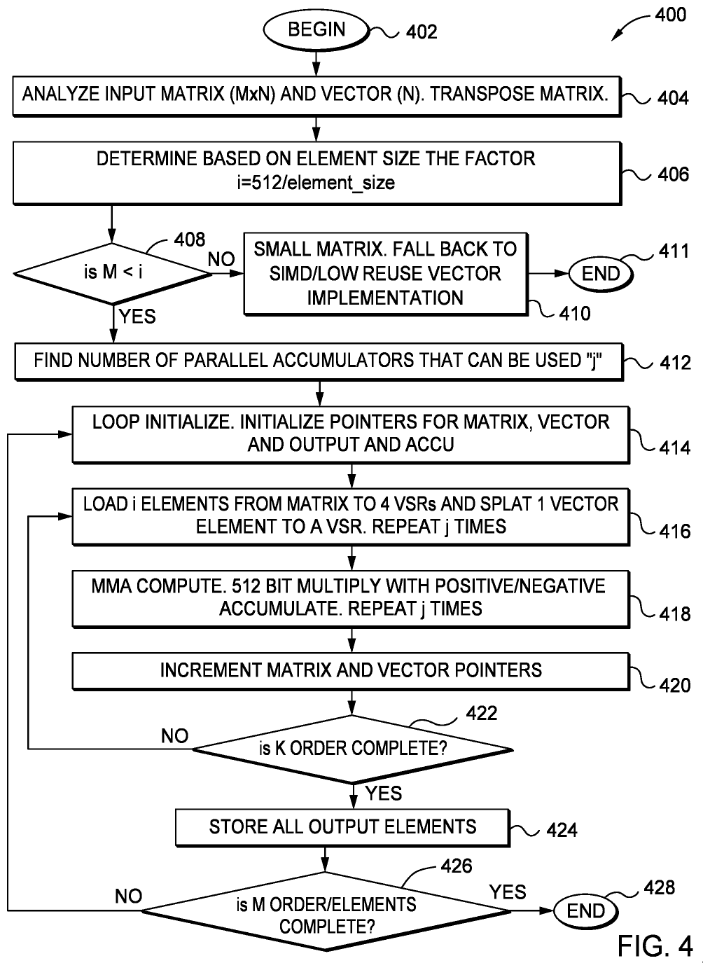

FIG. 4 illustrates an example method 400 for implementing acceleration of Matrix Math operations of Matrix-Vector multiplication and other Multiply-Add compute of disclosed embodiments. Method 400 illustrates example library functional steps that can be performed for example, using system 200 together with the computer 101 of FIG. 1, to enable selected operations by the MMA accelerator 204, with the MMA control component 182 based on the predefined instructions 184 and the defined configuration of VSRs 206, #1-5 of disclosed embodiments.

Method 400 starts at block 402. At block 404, system 200 analyzes input Matrix (M×N) and Vector (N), and transposes the Matrix, such as described and illustrated with respect to FIGS. 8 and 9. At block 406, system 200 determines based on an element size, a factor i=512/element size. For example, the factor i=512/element size equals four (4) with an element size of 128 bits. At decision block 408, system 200 determines whether M<i. For example, with a 4×4 (M×N) input Matrix, M equals 4, such as illustrated in subMatrixes 804, 814, 824, 834 in FIG. 8. At block 410, when M is not less than i, system 200 identifies a small matrix and operations can use a SIMD flow reuse vector implementation as described and illustrated in FIG. 8. Operations end at block 411.

At block 412, when M is less than to i, system 200 determines a number “j” of parallel accumulators of the compute engine 302 that can be used. For example with the 2×8 (M×N) subMatrixes 904, 914, 924, and 926 the operations at block 412 can be performed.

At block 414, system 200 initializes a compute loop, and initializes pointers for the matrix (e.g., VSR 206 #1-#4), vector (e.g., VSR 206 #5) and output and the accumulator 304 for the Matrix-Vector multiply operation. At block 416, system 200 loads i elements (e.g., four (4) matrix elements) from the input Matrix (e.g., VSR 206 #1-#4) and splat 1 vector element from a VSR 206, #5, and repeats j times (e.g., two times). For example, the splat 1 vector element input loads a pair of one scalar value, such as elements a, a, b, b, 906 in FIG. 9, to generate a partial product of the vector-matrix multiplication operation, and the partial product is accumulated with other partial products and a resulting accumulated partial product is stored.

At block 418, system 200 performs the MMA compute with 512 bit multiply with zero/positive/negative accumulate, and repeats j times (e.g., two times). At block 420, system 200 increments the matrix and vector pointers. At decision block 422, system 200 determines whether a K order of iterations for the overall Matrix-Vector multiply operation is complete. When the K order of iterations is not complete, system 200 returns to block 416 and loads i elements from the input Matrix (e.g. 914 in FIG. 9) to the VSR 206, #1-4 and splat 1 vector element to a VSR 206, #5, (such as elements c, c, d, d 916 in FIG. 9) and repeats j times, and continues as before. At block 424, when K order is complete, system 200 stores all output elements (e.g., final 512 bit compute result stored to compute engine accumulator 304. At decision block 426, system 200 determines whether M order/elements are complete. When, the M order/elements are not complete, system 200 returns to block 414, initializes the loop and initializes pointers for the matrix, vector and output and the accumulator 304 for the Matrix-Vector multiply operation, and continues to block 416 as before. At block 428, when the M order/elements are complete, operations for the Matrix-Vector multiply operation end.

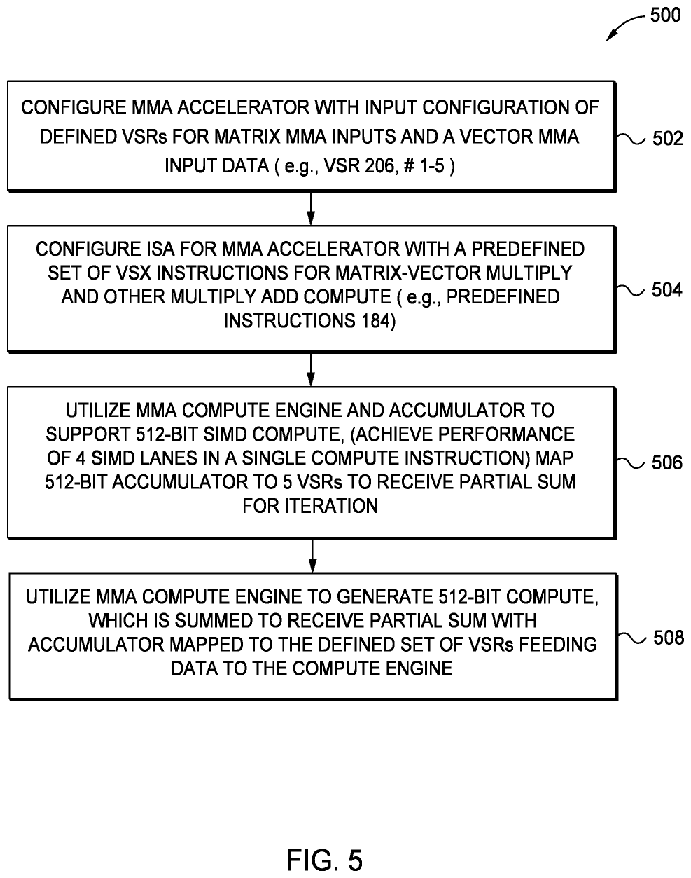

Referring to FIG. 5, an example method 500 illustrates example operations to implement the enhanced MMA accelerator 204 enabling acceleration of the Matrix-Vector Multiply and AXPY compute operations of disclosed embodiments. As indicated at a block 502, the MMA accelerator 204 is configured with an input VSR register configuration of a defined set of VSRs 206, #1-5 with four matrix MMA inputs from VSRs 206, #1-4, and a vector input VSR from VSR 206, #5 of vector elements. For example, as shown in FIG. 8, includes four respective matrix MMA inputs from VSRs 206, #1-4 are applied to the compute engine array 306 from the 4×4 submatrix 804, and a vector input VSR from VSR 206, #5 of vector elements a, b, c, d are provided for an initial compute iteration. For example, as shown in FIG. 9, four respective matrix MMA inputs from VSRs 206, #1-4 are respectively applied to rows of the compute engine array 306 from the 2×8 submatrix 904, and a vector input VSR from VSR 206, #5 of vector elements a, a, b, b are provided for an initial compute iteration.

At block 504, the set of predefined VSX instructions 184 are provided to the processor-chip instruction set architecture (ISA) for the MMA accelerator 204 of system 200 of disclosed embodiments. The ISA defines the supported instructions, data types, registers, the hardware support for managing main memory, fundamental features (such as the memory consistency, addressing modes, virtual memory), and the input/output model of a family of implementations of the ISA. As described before, the predefined VSX instructions 184 provide specific instructions for Matrix Math operations of the MMA 204 to carry out Matrix-Vector Multiply and AXPY compute operations, such as matrix-vector operations which can compute y=αAx+βy (where x and y are vectors, and A is a dense matrix).

As indicated at a block 506, the MMA 204 uses compute engine 302, which includes an existing configuration of an on-chip compute engine for matrix-matrix multiply operations. The compute engine 302 supports 512-bit compute for regular SIMD compute (e.g., to achieve performance of four (4) SIMD lanes in a single compute instruction 184). The MMA accelerator 204 can use a 512-bit accumulator (e.g., accumulator 304) of compute engine 302 mapped to the multiple VSRs 206, #1-4 for matrix-vector multiply, and other multiply add partial sum compute operations. At block 508, the compute engine 302 is used to generate a 512 bit arithmetic compute, which is summed to the accumulator 304 with the defined set of VSRs 206, #1-5 feeding data in a masked way to the compute engine 302.

While the foregoing is directed to embodiments of the present invention, other and further embodiments of the invention may be devised without departing from the basic scope thereof, and the scope thereof is determined by the claims that follow.

What is claimed is:

1. A method, comprising:
configuring a set of defined input registers to provide multiple matrix data inputs and a vector data input to a compute engine of a Matrix Math Assist (MMA) accelerator;
providing predefined instructions to support matrix-vector multiply and multiply-add compute operations by the compute engine;
providing an accumulator of the compute engine mapped to the multiple matrix data input registers for accelerating Matrix-Vector multiply and Multiply-Add compute operations by the compute engine; and
selectively feeding input data from the defined set of input registers to the compute engine for multiply and multiply add compute operations based on one or more of the predefined instructions; and
generating compute results based on the compute engine operations and the input data, wherein the compute results are summed to the accumulator of the compute engine.

2. The method of claim 1, wherein the set of defined input registers comprises a set of Vector Scalar Registers (VSRs) coupled to the compute engine, the VSRs having a size based on the compute engine.

3. The method of claim 1, wherein the predefined instructions comprise predefined Vector Scalar Extension (VSX) instructions added to an instruction set architecture (ISA) of the MMA accelerator for the Matrix-Vector multiply and Multiply-Add compute operations.

4. The method of claim 1, wherein the compute engine comprises a compute array, and wherein based on based on one or more of the predefined instructions, each row of the compute array is loaded with matrix data from a respective one of the defined registers and multiplied with a predefined vector element input from the vector data input register.

5. The method of claim 1, wherein selectively feeding input data from the defined set of registers to the compute engine comprises selectively feeding input matrix data elements from a respective one of the defined registers to a respective row of a compute array, feeding a respective input vector element from the vector data input register to the respective row of input matrix data elements, and multiplying in parallel the respective input vector element to the matrix data elements of each of the respective compute array rows.

6. The method of claim 1, wherein selectively feeding input data from the defined set of registers to the compute engine comprises feeding respective input matrix data elements and respective input vector elements from the defined registers to the compute engine, multiplying the respective input matrix data elements and respective input vector elements, and summing multiplied results to the accumulator of the compute engine.

7. The method of claim 1, wherein selectively feeding input data from the defined set of registers to the compute engine comprises feeding consecutive vector data elements from the defined registers to a respective row of a compute array and multiplying a scalar element from one defined register to each vector data element based on a predefined instruction supporting the Multiply-Add compute operations of the compute engine.

8. The method of claim 1, wherein the predefined instructions comprise predefined MMA Vector Scalar Extension (VSX) instructions to support predefined precision levels of floating point and Integer operations, the MMA VSX instructions control the compute engine including the accumulator.

9. The method of claim 1, wherein the defined input registers comprise Vector Scalar Registers (VSRs) of 128-bits storing four 32-bit data elements to be multiplied and accumulated to a 512-bit accumulator.

10. The method of claim 1, further comprises receiving an input M×N matrix having M rows and N columns with consecutive data elements in the M rows, wherein the input M×N matrix is larger than a compute array of the compute engine, and transforming the input M×N matrix to provide the consecutive data elements in the N columns, and dividing the transformed matrix into subMatrixes based a size of the compute array of the compute engine.

11. A system, comprising:
a processor; and
a memory, wherein the memory includes a computer program product which, when executed, configure the processor to perform operations for implementing a Matrix Math Assist (MMA) accelerator for accelerating operations of Matrix-Vector multiply, Multiply-Add compute and mixed Matrix-Matrix multiply and Matrix-Vector multiply compute patterns, the operations comprising:
configuring a set of defined input registers to provide multiple matrix data inputs and a vector data input to a compute engine of the MMA accelerator;
providing predefined instructions to support matrix-vector multiply and multiply-add compute operations by the compute engine;
providing an accumulator of the compute engine mapped to the multiple matrix data input registers for accelerating Matrix-Vector multiply and Multiply-Add compute operations by the compute engine; and
selectively feeding input data from the defined set of input registers to the compute engine for multiply and multiply add compute operations based on one or more of the predefined instructions; and
generating compute results based on the compute engine operations and the input data, wherein the compute results are summed to the accumulator of the compute engine.

12. The system of claim 11, wherein the set of defined input registers comprises a set of Vector Scalar Registers (VSRs) coupled to the compute engine, the VSRs having a size based on the compute engine.

13. The system of claim 11, wherein the predefined instructions comprise predefined Vector Scalar Extension (VSX) instructions added to an instruction set architecture (ISA) of the MMA accelerator for the Matrix-Vector multiply and Multiply-Add compute operations.

14. The system of claim 11, wherein the compute engine comprises a compute array, and wherein based on based on one or more of the predefined instructions, each row of the compute array is loaded with matrix data from a respective one of the defined input registers and multiplied with a predefined vector element from the defined vector data input register.

15. The system of claim 11, wherein selectively feeding input data from the defined set of registers to the compute engine comprises feeding consecutive vector data elements from the defined registers to a respective row of a compute array and multiplying a scalar element from one defined register to each vector data element based one predefined instruction supporting the Multiply-Add compute operations of the compute engine.

16. A computer program product for accelerating operations of Matrix-Vector multiply, Multiply-Add compute and mixed Matrix-Matrix multiply and Matrix-Vector multiply compute patterns with a Matrix Math Assist (MMA) accelerator, the computer program product comprising:
a computer-readable storage medium having computer-readable program code embodied therewith, the computer-readable program code executable by one or more computer processors to perform an operation comprising:
configuring a set of defined input registers to provide multiple matrix data inputs and a vector data input to a compute engine of the MMA accelerator;
providing predefined instructions to support matrix-vector multiply and multiply-add compute operations by the compute engine;
providing an accumulator of the compute engine mapped to the multiple defined input registers for accelerating Matrix-Vector multiply and Multiply-Add compute operations by the compute engine; and
selectively feeding input data from the defined set of input registers to the compute engine for multiply and multiply add compute operations based on one or more of the predefined instructions; and
generating compute results based on the compute engine operations and the input data, wherein the compute results are summed to the accumulator of the compute engine.

17. The computer program product of claim 16, wherein the set of defined input registers comprises a set of Vector Scalar Registers (VSRs) coupled to the compute engine, the VSRs having a size based on the compute engine.

18. The computer program product of claim 16, wherein the predefined instructions comprise predefined Vector Scalar Extension (VSX) instructions added to an instruction set architecture (ISA) of the MMA accelerator for the Matrix-Vector multiply and Multiply-Add compute operations.

19. The computer program product of claim 16, wherein the compute engine comprises a compute array, and wherein based on one or more of the predefined instructions, each row of the compute array is loaded with matrix data from a respective one of the defined input registers and multiplied with a predefined vector element from the defined vector data input register.

20. The computer program product of claim 16, wherein selectively feeding input data from the defined set of registers to the compute engine comprises feeding consecutive vector data elements from the defined registers to a respective row of a compute array and multiplying a scalar element from one defined register to each vector data element based one predefined instruction supporting the Multiply-Add compute operations of the compute engine.
